(19) United States
(12) Patent Application Publication
(10) Pub. No.: US 2006/0174351 A1
(43) Pub. Date: Aug. 3, 2006

(54) Method and system for CAS key assignment for digital broadcast service

(75) Inventors: Sung-Joon Park, Seoul (KR); Tae-Chul Jung, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/335,593

(22) Filed: Jan. 20, 2006

(30) Foreign Application Priority Data
Feb. 1, 2005 (KR) 2005-9124

(51) Int. Cl. H04L 9/32

(52) U.S. Cl. 726/27

(57) ABSTRACT

A method for assigning conditional access system (CAS) keys to a terminal to thus reduce the number of entitlement management messages (EMMs) required to send contents to a digital broadcast subscriber. To this end, a broadcast center causes transmission of the CAS-related key to limit access to the digital content, over a mobile communication network used for a mobile communication, and causes transmission of the digital content over a digital broadcasting network used for digital broadcasts. Since the CAS-related key is transmitted to the digital broadcast subscriber's terminal over the mobile communication network, it is possible to effectively utilize the frequency bandwidth of the digital broadcasting network for the digital broadcasting. Furthermore, the security of the CAS-related key can be strengthened by sending the CAS-related key to the terminal over the mobile communication network.

### CROSS-REFERENCE TO RELATED APPLICATIONS

This application claims the benefit under 35 U.S.C. § 119 (a) from Korean Patent Application No. 2005-09124 filed on Feb. 1, 2005 in the Korean Intellectual Property Office, the entire disclosure of which is incorporated herein by reference.

### BACKGROUND OF THE INVENTION

1. Field of the Invention

Apparatuses and methods consistent with the present invention relate generally to a conditional access system (CAS) key assignment. More particularly, such apparatuses and methods relate to reducing the number of entitlement management messages (EMMs) required to provide content to authorized digital broadcast subscribers.

2. Description of the Related Art

Satellite and terrestrial digital broadcasting provides customized services to subscribers. Broadcasters have introduced a subscription model to existing television (TV) terrestrial broadcast services that mainly depends on advertising revenue and provides various programs to a limited number of subscribers who pay a service rate. Digital broadcasting enables offering various productions and services of specialized programs by specialized contents providers.

As subscription fees, rather than merely advertising revenue, are used to fund broadcasters, subscribers can enjoy specialized channels and customized services of high quality in the multichannel broadcasting era. A conditional access system (CAS) enables the conditional limited reception of a broadcast. With CAS, only authorized subscribers can receive a scrambled signal broadcast from a transmitting end and descramble the received signal to view the program.

Requirements of the CAS are the scrambling of programs (contents) and data, and the protection of the scrambled data over a communication channel. Additionally, CAS requires use of the subscriber authentication function and the access control function. The two requirements aim for the protection of the resources (programs and data) and the subscribers. The scrambling and the descrambling are for the resource's protection, and the subscriber authentication function and the access control function are for the subscriber's protection. Hereafter, the CAS is described in more detail.

CAS includes scrambling and descrambling, the entitlement control function, and the entitlement management function.

Scrambling encrypts data to be transmitted using a control word (CW) to protect the data from access by unauthorized subscribers. The descrambling is performed only by a receiver that can acquire the descrambler key CW. Generally, the CW can be decrypted using a direct entitlement key (DEK).

The entitlement control function sends an entitlement control message (ECM). The ECM includes the encrypted CW and an address parameter, and is transmitted at regular intervals. The receiving end provides the received ECM to a smart card. A microprocessor in the smart card compares the provided address parameter with an authentication parameter held by the smart card. When the two parameters match, the authentication process at the receiving end terminates and the CW is decrypted using the DEK of the authorized smart card. Typically, the CW differs for each program or data.

The entitlement management function grants access rights to the receiving end, or updates the authentication key. The entitlement management function generates an entitlement management message (EMM). The receiving end decrypts the DEK of the EMM using a user key stored in the smart card. In general, the EMM can be divided as follows:
EMM_B: to allow access of all receiving ends
EMM_G: to allow access of a group including at least one receiving end
EMM_P: to allow access of one receiving end

With reference to FIG. 1, the following describes how a conventional terminal obtains a plurality of CAS keys.

The terminal 100 stores a master private key (MPK) in a smart card (S100). Principally, when the smart card is issued, the MPK is stored therein.

The digital broadcasting network 102 encrypts a private key (PK) using the MPK and transmits the encrypted PK to the terminal 100 using an EMM_P (S112). The terminal 100 acquires the encrypted PK contained in the received EMM_P by use of the MPK (S114).

The digital broadcasting network 102 encrypts a group key (GK) using the MPK and transmits the encrypted GK to the terminal 100 using an EMM_G (S116). The terminal acquires the encrypted GK contained in the received EMM_G by using the stored MPK (S118).

The digital broadcasting network 102 encrypts a broadcast key (BK) using the MPK and transmits the encrypted BK to the terminal 100 using an EMM_B (S120). The terminal acquires the encrypted BK contained in the received EMM_B using the MPK (S122). Primarily, the user key includes the MPK, the PK, the GK, and the BK.

The digital broadcasting network 102 encrypts the DEK using the PK and transmits the encrypted DEK to the terminal 100 using an EMM_P (S124). The terminal 100 acquires the encrypted DEK contained in the received EMM_P using the stored PK (S126).

The digital broadcasting network 102 encrypts the DEK using the GK and transmits the encrypted DEK to the terminal 100 using an EMM_G (S128). The terminal 100 acquires the encrypted DEK contained in the received EMM_G using the stored GK (S130).

The digital broadcasting network 102 encrypts the CW using the DEK and transmits the encrypted CW to the terminal 100 using an ECM (S132). The terminal 100 acquires the encrypted CW of the received ECM using the stored DEK (S134). It is noted that the digital broadcasting network 102 encrypts the CW destined for the terminal 100 using the DEK relating to the PK, and the CW destined for the group using the DEK relating to the GK.

As such, the more subscribers present in the digital broadcasting network, the more EMM_P messages are transmitted over the digital broadcasting network to each terminal for distributing the keys. As discussed above, to provide various content and data to the subscribers, the digital broadcasting network requires a plurality of transmission channels. In response to this, a new method is needed to efficiently utilize the limited bandwidth of the digital broadcasting network.

### SUMMARY OF THE INVENTION

Apparatuses and methods consistent with the present invention address the above-mentioned and other problems and disadvantages occurring in the conventional arrangement, and an aspect of the present invention provides a CAS configuration for reducing the number of EMM_P messages transmitted to each terminal from the digital broadcasting network.

Another aspect of the present invention provides a method for providing various types of content by efficiently utilizing limited radio resources of the digital broadcasting network.

Still another aspect of the present invention provides a method for reducing the number of EMM_P messages transmitted to each terminal from the digital broadcasting network even when the number of subscribers of the digital broadcasting network increases.

To achieve the above aspects of the present invention, a method for providing digital content to a terminal and a conditional access system (CAS) related key to limit access to the digital content, includes transmitting the CAS-related key over a mobile communication network used for mobile communications; and transmitting the digital content using a digital broadcasting network used for digital broadcasts.

A system for providing a conditional access system (CAS) related key and a digital content, includes a terminal; and a broadcast center which causes the CAS-related key for limiting access to the digital content to be transmitted over a mobile communication network used for mobile communications, and causes the digital content to be transmitted over a digital broadcasting network used for digital broadcasts.

### BRIEF DESCRIPTION OF THE DRAWING FIGURES

Aspects of the invention will become apparent and more readily appreciated from the following description of illustrative, non-limiting embodiments, taken in conjunction with the accompanying drawing figures of which:

FIG. 1 is a flow diagram illustrating a CAS key assignment for a digital broadcast at a conventional terminal;

FIG. 2 is a diagram of broadcasting services provided from a broadcast center, which are grouped based on a service type and a service duration;

FIG. 3 is a schematic block diagram illustrating a CAS key assignment at a terminal according to an embodiment of the present invention;

FIG. 4 is a flow diagram illustrating the CAS key assignment for a digital broadcast at the terminal according to an embodiment of the present invention; and

FIG. 5 is a flow diagram illustrating service extension request operations between a terminal, a mobile communication network, and a broadcast center.

### DETAILED DESCRIPTION OF EXEMPLARY EMBODIMENTS

Reference will now be made in detail to exemplary embodiments of the present general inventive concept, examples of which are illustrated in the accompanying drawings, wherein like reference numerals refer to like elements throughout. These embodiments are described below in order to explain the present general inventive concept by referring to the drawings.

Hereinafter, descriptions of a conditional access system (CAS) configuration for reducing the number of EMM_Ps transmitted to a terminal from a digital broadcasting network according to an embodiment of the present invention are made with reference to the attached drawings.

According to an embodiment of the present invention, an EMM_P message transmitted to a terminal is eliminated, subscribers are grouped into a plurality of groups, and a unique key is assigned to each group. The unique key assigned to each group is transferred to each terminal over a mobile communication network rather than over a digital broadcast network.

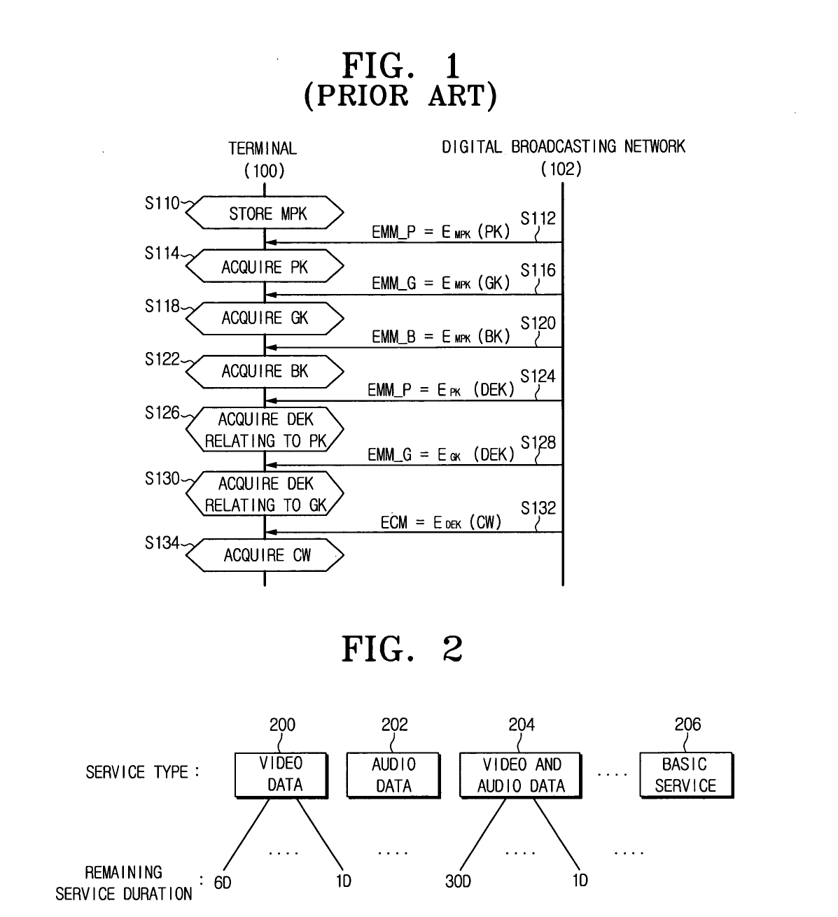

FIG. 2 illustrates a plurality of groups of digital broadcast subscribers. In the embodiment of the present invention, the subscribers are grouped based on the type of service to which they subscribe (hereinafter “service type”) and the remaining duration of the subscribed service. It is to be understood that the subscribers can be grouped based on other criteria selected by a user.

Referring to FIG. 2, the services are grouped based on the service type, such as video data 200, audio data 202, video and audio data 204, and a basic service 206. The video data 200 is grouped based on the remaining service duration, such as 6 days (D) through 1D. The video and audio data 204 is grouped according to its remaining service duration, such as 30D through 1D. Although not shown in FIG. 2, the audio data 202 and the basic service 206 are also grouped into a plurality of groups according to the remaining service duration.

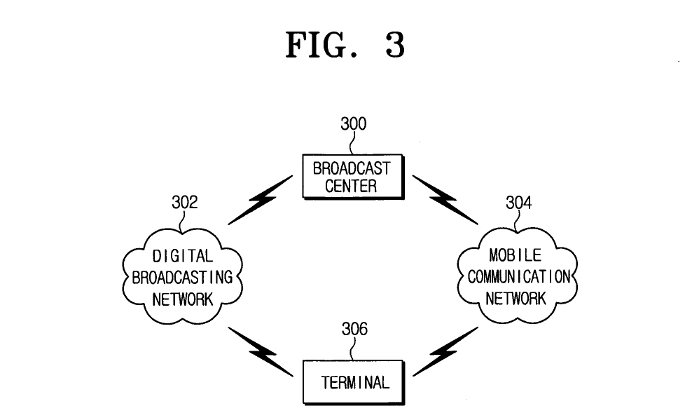

FIG. 3 depicts a digital broadcast subscriber's terminal 306 and communication networks 302 and 304 connected to the terminal 306 according to an embodiment of the present invention. As shown in FIG. 3, the terminal 306 is connected to the digital broadcasting network 302 and the mobile communication network 304. A broadcast center 300 is connected to the digital broadcasting network 302 and the mobile communication network 304 as well. Although FIG. 3 depicts a direct connection from the broadcast center 300 to the digital broadcasting network 302 and to the mobile communication network 304, the broadcast center 300 may be indirectly connected according to a user's setting.

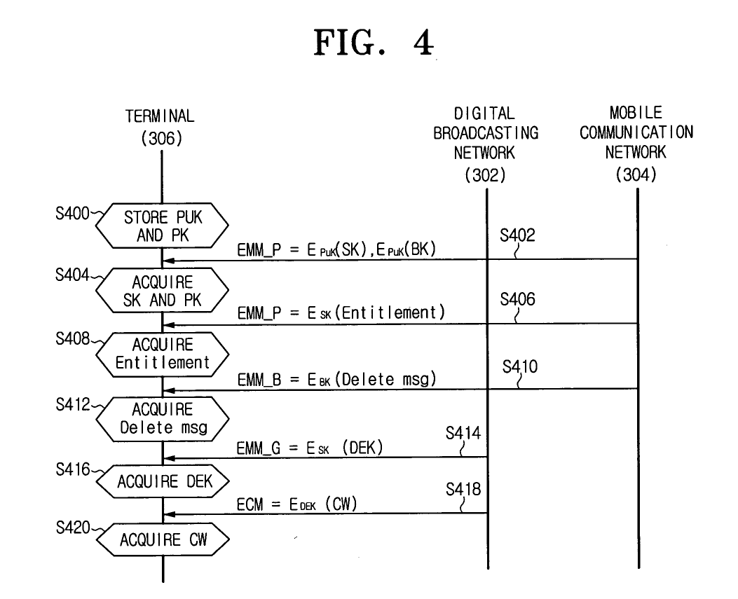

The method for assigning a key in order for the terminal 306 to receive the digital broadcast will be elucidated below with reference to FIG. 4.

The terminal 306 stores a public key (PuK) and a PK in its smart card (S400). The mobile communication network 304 encrypts a subscription key (SK) using the PuK and transmits an EMM_P containing the encrypted SK (S402). In the embodiment of the present invention, the key structure is the public key structure. The public key structure includes the PuK of the terminal 306 and the PK corresponding to the PuK. The terminal 306 sends its PuK to the broadcast center 300. The broadcast center 300 encrypts specific information using the PuK and transmits the encrypted information, and the terminal 306 acquires the specific information using the stored PK. In other words, the terminal 306 cannot acquire the specific information provided from the broadcast center with a different PK.

Table 1 shows exemplary SKs transmitted to the groups shown in FIG. 2.

TABLE 1

| Service Type | Remaining Service Duration | Subscription Key |
|---|---|---|
| Video data | 6 D | SK0 |
| | . . . | . . . |
| | 1 D | SKk |
| Audio data | . . . | . . . |
| Video and audio data | 30 D | SKm |
| | . . . | . . . |
| | 1 D | SKn |
| . . . | . . . | . . . |
| Basic service | . . . | . . . |

In Table 1, SK0 is assigned to the terminal 306 of the subscriber who requests video data with the service duration of 6D remaining, and SKk is assigned to the terminal 306 of the subscriber who requests video data with the service duration of 1D remaining. SKm is assigned to the terminal 306 of the subscriber who requests video and audio data with the service duration of 30D remaining, and SKn is assigned to the terminal 306 of the subscriber who requests video and audio data with the service duration of 1D remaining.

Although different SKs are assigned to the groups in Table 1, the same SK is assignable to the groups, according to a user's setting.

It is exemplified that the user assigns the same SK to the groups. The same SK can be assigned to the terminal 306 of the subscriber who requests video data. In this case, the SK can be encrypted using different encryption algorithms depending on the duration of the remaining service. More specifically, SK0 is assigned to the terminal 306 of the subscriber requesting video data. Encryption using (SK0) is conducted for the terminal 306 having 6D of service duration remaining, and encryption using (SK0) is conducted for the terminal 306 having the 1D service duration remaining. A detailed explanation as to the hash function (algorithm) will be omitted for brevity. Note that the SK assigned to the groups is changeable by the day.

The mobile communication network 304 encrypts the BK using the PuK and transmits an EMM_P containing the encrypted BK to the terminal (S402). The terminal 306 acquires the SK and the BK in the received EMM_P using the stored PuK (S404).

The mobile communication network 304 encrypts information to be transmitted to the terminal 306 using the SK and transmits the encrypted information to the terminal 306 using an EMM_P (S406). In FIG. 4, the information to be transmitted to the terminal is an Entitlement message, for example. The terminal 306 acquires the information relating to the Entitlement in the EMM_P using the stored SK (S408).

The mobile communication network 304 encrypts information to be transmitted to the terminal 306 of the digital broadcast subscriber, using the BK and transmits the encrypted information to the terminal 306 using an EMM_P (S410). In FIG. 4, the information transmitted to the terminal 306 of the digital broadcast subscriber is a Delete message, for example. The Delete message instructs to delete digital broadcasting contents, etc. The terminal 306 acquires the Delete message in the EMM_P by using the stored BK (S412).

The digital broadcasting network 302 encrypts the DEK using the SK and transmits the encrypted DEK to the terminal 306 using an EMM_G (S414). The terminal 306 acquires the DEK in the EMM_G using the stored SK (S416).

The digital broadcasting network 302 encrypts the CW using the DEK and transmits the encrypted CW to the terminal 306 using the ECM (S418). The terminal 306 acquires the CW in the ECM using the stored DEK (S420).

Next, the terminal 306 decrypts the contents received from the digital broadcasting network 302 and thus displays the intended contents.

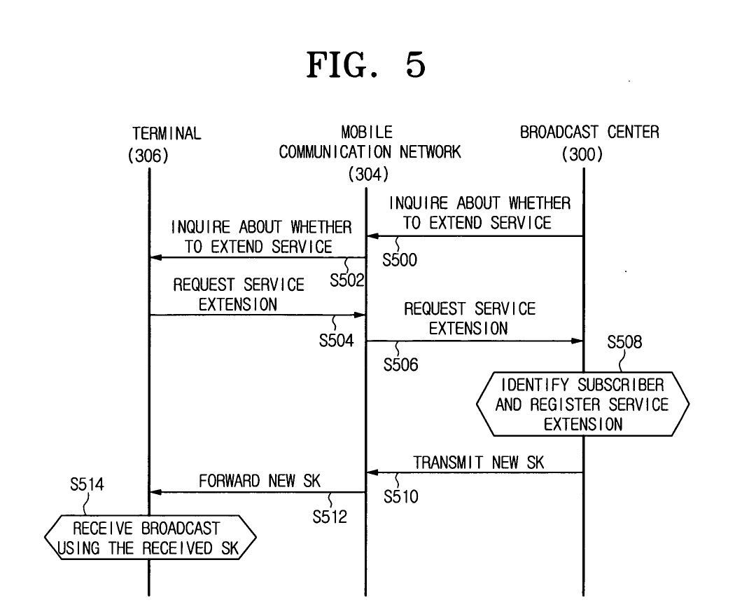

FIG. 5 illustrates how the subscriber extends its requested services according to an embodiment of the present invention, to be set forth in detail below.

The broadcast center 300 inquires of the mobile communication network 304 about whether to extend the service or not when the expiration of the service duration is close (S500). The mobile communication network 304 inquires of the terminal 306 about whether to extend the service (S502). Although the broadcast center 300 inquires as to whether to extend the service in FIG. 5, operation S500 and S502 can be omitted. Accordingly, when the service duration is to expire, the subscriber can send a request for a service extension to the broadcast center 300.

If the terminal 306 determines that it will extend the service duration in response to the request of the mobile communication network 304, it informs the mobile communication network 304 of the service extension (S504). It is to be noted that the terminal 306 can request other services in addition to the existing services. The mobile communication network 304 forwards the service extension request of the terminal 306 to the broadcast center 300 (S506).

The broadcast center 300 identifies the subscriber who requests the service extension, and updates its stored subscriber information according to the service extension request (S508). Specifically, the broadcast center 300 updates the service type when the subscriber requests additional service, and updates the service duration when the service duration extension is requested. The broadcast center 300 redefines the fee charged to the subscriber according to the subscriber information update.

The broadcast center 300 transmits to the mobile communication network 304 a SK that corresponds to the service type requested by the subscriber and the remaining service duration (S510). The mobile communication network 304 forwards the new SK to the terminal 306 (S512). The terminal 306 receives the desired broadcast using the received SK (S514).

Although FIG. 5 shows that the broadcast center 300 inquires only as to whether to extend the service duration, it can also inquire, according to a user's setting, whether to change the service type. It is to be understood that the broadcast center 300 can inquire of both a service extension and a service type change.

As set forth above, the SK, which requires security, is transmitted over the mobile communication network, and the substantial broadcast service is provided over the digital broadcast network.

Since the CAS-related key is transmitted to the terminal of the digital broadcast subscriber over the mobile communication network rather than over the digital broadcast network, it is possible to effectively utilize the frequency bandwidth for the digital broadcasting. Furthermore, the security of the CAS-related key can be strengthened by providing the CAS-related key to the terminal over the mobile communication network.

Although a few embodiments of the present invention have been shown and described, those skilled in the art will appreciate that changes may be made in these embodiments without departing from the principles and spirit of the invention, the scope of which is defined in the claims and their equivalents.

What is claimed is:

1. A method for providing digital content to a terminal and an access control key to limit access to the digital content, the method comprising:
transmitting the access control key over a communication network;
transmitting the digital content using a digital broadcasting network used for digital broadcasts.

2. The method of claim 1, wherein the communication network and the digital broadcasting network are different networks.

3. The method of claim 1, wherein the communication network is a mobile communication network.

4. The method of claim 3, wherein the access control key is a conditional access system (CAS) related key.

5. The method of claim 4, wherein the terminal is one of a plurality of terminals that are grouped into at least two groups according to bases including a type and a duration of a requested content, and a unique subscription key (SK) is assigned to each group.

6. The method of claim 5, wherein a stored PuK is associated with a private key (PK), and the PuK is transmitted to the terminal.

7. The method of claim 6, wherein the SK is encrypted using the received PuK and the encrypted SK is transmitted to the terminal over the mobile communication network.

8. The method of claim 7, wherein information to be transmitted is encrypted using the SK and the encrypted information is provided to the terminal over the mobile communication network.

9. The method of claim 6, wherein a broadcast key (BK) is encrypted using the received PuK and the encrypted BK is transmitted to the terminal over the mobile communication network.

10. The method of claim 9, wherein information to be transmitted is encrypted using the BK and the encrypted information is provided to the terminal over the mobile communication network.

11. The method of claim 6, wherein a direct entitlement key (DEK) is encrypted using the SK and the encrypted DEK is transmitted to the terminal over the digital broadcast network.

12. The method of claim 11, wherein a control word (CW) is encrypted using the DEK and the encrypted CW is transmitted to the terminal over the digital broadcast network.

13. The method of claim 12, wherein the content is encrypted using the CW and the encrypted content is transmitted to the terminal over the digital broadcasting network.

14. The method of claim 5, wherein, if at least one of the type and the duration of the requested service are changed, a SK corresponding to said at least one of the changed type and duration is transmitted to the terminal over the mobile communication network.

15. A system for providing an access control key and a digital content, comprising:
a terminal; and
a broadcast center which causes transmission of the access control key to limit access to the digital content, over a communication network, and causes transmission of the digital content over a digital broadcasting network used for a digital broadcast.

16. The system of claim 15, wherein the communication network and the digital broadcasting network are different networks.

17. The system of claim 15, wherein the communication network is a mobile communication network.

18. The system of claim 17, wherein the access control key is a conditional access system (CAS) related key.

19. The system of claim 18, wherein the terminal is one of a plurality of terminals that are grouped into at least two groups according to bases including a type and a duration of a requested content, and a unique subscription key (SK) is assigned to each group.

20. The system of claim 19, wherein a stored PuK is associated with a private key (PK) and the terminal transmits the PuK to the broadcast center over the mobile communication network.

21. The system of claim 20, wherein the broadcast center encrypts the SK using the received PuK and transmits the encrypted SK to the terminal over the mobile communication network.

22. The system of claim 21, wherein the broadcast center encrypts information to be transmitted using the SK and transmits the encrypted information to the terminal over the mobile communication network.

23. The system of claim 20, wherein the broadcast center encrypts a direct entitlement key (DEK) using the SK and transmits the encrypted DEK to the terminal over the digital broadcast network.

24. The system of claim 23, wherein the broadcast center encrypts a control word (CW) using the DEK and transmits the encrypted CW to the terminal over the digital broadcast network.

25. The system of claim 24, wherein the broadcast center encrypts the content using the CW and transmits the encrypted content to the terminal over the digital broadcasting network.

26. The system of claim 19, wherein, if at least one of the type and the duration of the requested service are changed, the broadcast center transmits a SK corresponding to the changed type and duration to the terminal over the mobile communication network.

27. A method for a terminal receiving digital content and an access control key to limit access to the digital content, the method comprising:
receiving the access control key over a communication network; and
receiving the digital content using a digital broadcasting network used for digital broadcasts.

28. The method of claim 27, wherein the communication network and the digital broadcasting networks are different networks.

29. The method of claim 27, wherein the communication network is a mobile communication network.

30. The method of claim 29, wherein the access control key is a conditional access system (CAS) related key.

31. The method of claim 30, wherein the terminal is one of a plurality of terminals that are grouped into at least two groups according to bases including a type and a duration of a requested content, and a unique subscription key (SK) is assigned to each group.

32. The method of claim 31, wherein a stored PuK is associated with a private key (PK), and the PuK is received by the terminal.

33. The method of claim 32, wherein the SK is encrypted using the received PuK and the encrypted SK is received by the terminal over the mobile communication network.

34. The method of claim 33, wherein information to be transmitted is encrypted using the SK and the encrypted information is received by the terminal over the mobile communication network.

35. The method of claim 32, wherein a broadcast key (BK) is encrypted using the received PuK and the encrypted BK is received by the terminal over the mobile communication network.

36. The method of claim 35, wherein information to be transmitted is encrypted using the BK and the encrypted information is received by the terminal over the mobile communication network.

37. The method of claim 32, wherein a direct entitlement key (DEK) is encrypted using the SK and the encrypted DEK is received by the terminal over the digital broadcast network.

38. The method of claim 37, wherein a control word (CW) is encrypted using the DEK and the encrypted CW is received by the terminal over the digital broadcast network.

39. The method of claim 38, wherein the content is encrypted using the CW and the encrypted content is received by the terminal over the digital broadcasting network.

40. The method of claim 31, wherein, if at least one of the type and the duration of the requested service are changed, a SK corresponding to said at least one of the changed type and duration is received by the terminal over the mobile communication network.
